(19) United States
(12) Patent Application Publication
(10) Pub. No.: US 2019/0295196 A1
(43) Pub. Date: Sep. 26, 2019

(54) COMPARABILITY SCORE USING MULTI-CHARACTERISTIC DIMENSION REDUCTION METHOD

(71) Applicant: First American Financial Corporation, Santa Ana, CA (US)

(72) Inventor: Mark M. Fleming, Santa Ana, CA (US)

(21) Appl. No.: 15/927,960

(22) Filed: Mar. 21, 2018

(51) Int. Cl. G06Q 50/16; G06Q 10/06; G06Q 30/02

(52) U.S. Cl. CPC G06Q 50/16; G06Q 30/0206; G06Q 10/067

(57) ABSTRACT

The disclosure describes systems and methods for measuring the multi-characteristic degree of comparability of a subject property and each of a set of potential comparable properties searched in one or more databases based on geographical proximity to the subject property and most recent sale date. A multi-characteristic dimension reduction method may be used that includes derived importance weights of property characteristics to create an objective measure of comparability distance, between a subject property and a compared property. The measure may be applied to calculate the comparability distances for all potential comparable properties. The distance measure may be applied to calculate the distances for all comparable properties selected on an appraisal. The distances of the appraisal selected comparable properties may be compared to the distances for all searched potential comparable properties to score or otherwise assess the appropriateness of an appraiser selected dataset.

### BACKGROUND

Determination of the quality of an appraisal is important within the overall assessment of mortgage risk in a loan transaction. The amount of equity available at the time of origination is an important indicator of the likelihood of future default and loss to the mortgage lender. The appraised value represents an independent assessment of market value that can be used to determine the origination equity position. Because the final appraised value is largely a function of the comparable properties an appraiser selects, one way to assess the quality of the final assessed value is by assessing the reasonableness of the comparable properties.

Historically, an appraisal is manually reviewed by an individual with a primary goal being an assessment of whether the comparable properties provided by the appraiser are “correct” or “good”. A heuristic, or set of rules, are applied to compare the property characteristics of the subject property to the characteristics of the comparable properties. If the difference in any individual characteristic exceeds a set threshold, the comparable is deemed “suspicious” and further evidence is required to prove that this comparable should be selected instead of others. For example, if the livable square footage difference exceeds 10 percent would be an example heuristic rule that may be used.

### BRIEF SUMMARY OF THE DISCLOSURE

The disclosure describes systems and methods for measuring the multi-characteristic degree of comparability of a subject property and each of a set of potential comparable properties searched in one or more databases based on geographical proximity to the subject property and most recent sale date.

In one example, a method includes: initializing an application instance; setting, at the application instance, a subject property; searching one or more databases for a plurality of potential comparable properties to the subject property using at least a configured geographical proximity to the subject property and a configured sale date; retrieving, from the one or more databases, sales price and characteristic data for each of the searched plurality of potential comparable properties; estimating a value of the subject property and each of the plurality of potential comparable properties as a function of a weighted sum of characteristics of the property, wherein weights for the weighted sum are derived from a sample of observed sale price and characteristic combinations based on one or more automated valuation models; computing comparability distances of each of the potential comparable properties to the subject property based on a difference between the estimated value of the subject property and the estimated value of the potential comparable property; and standardizing each of the computed comparability distances.

In implementations, the method may further include: receiving an appraisal property dataset comprising a plurality of properties comparable to the subject property, wherein the operations of estimating a value, computing a comparability distance to the subject property, and standardizing the computed comparability distance are performed for each of the plurality of properties of the appraisal property dataset.

In implementations, the computed comparability distances are standardized based on dᵢⱼ^{x}=dᵢⱼ/max(dᵢⱼ)∀j for {j:c∈C,p∈P}, where dᵢⱼ^{x} is a standardized comparability distance of a potential comparable property j to the subject property i, where C is a set including each of the plurality of properties c of the appraisal dataset, and where P is a set including each of the plurality of properties p of the potential comparable properties.

In implementations, the method further includes: determining a comparability score of the plurality of properties of the appraisal property dataset using at least the standardized comparability distance computed for each of the properties of the appraisal property dataset. In particular implementations, the comparability score is determined based on

$${Cscore}_{i} = \frac{{\sum }_{c = 1}^{C} {d}_{ic}^{s}}{C} , ∀ c ,$$

where Cscoreᵢ is the mean standardized comparability distance of the standardized comparability distances of the plurality of properties of the appraisal property dataset.

In implementations, the method further includes: determining if the comparability score exceeds a threshold standardized comparability distance.

In implementations, the method further includes: displaying a graphical representation of the standardized comparability distances of the plurality of properties of the appraisal property dataset as compared to the standardized comparability distances of the plurality of potential comparable properties. In particular implementations, the graphical representation is a plot showing a cumulative percentage of the plurality of potential comparable properties as a function of standardized comparability distance.

In implementations, weights for the weighted sum are derived from a sample of observed sale price and characteristic combinations based on a weighted ensemble of a plurality of automated valuation models.

In implementations, the method further includes: storing the comparability score in an appraisal database; updating a cumulative comparability score of an appraiser associated with the appraisal dataset in the appraisal database using at least the determined comparability score; and updating a ranking of the appraiser in the appraiser database using at least the updated cumulative comparability score and stored cumulative comparability scores of other appraisers.

In implementations, setting the subject property includes: presenting a graphical user interface for searching data about the subject property; and receiving data corresponding to user input searching the subject property, and the method further includes: ranking the potential comparable properties using at least the standardized comparability distances; and displaying data about the potential comparable properties in ranked order.

Other features and aspects of the disclosure will become apparent from the following detailed description, taken in conjunction with the accompanying drawings, which illustrate, by way of example, the features in accordance with various embodiments. The summary is not intended to limit the scope of the invention, which is defined solely by the claims attached hereto.

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate the reader's understanding of various embodiments and shall not be considered limiting of the breadth, scope, or applicability of the present disclosure. It should be noted that for clarity and ease of illustration these drawings are not necessarily made to scale.

FIG. 1 illustrates an example system in which implementations of the disclosure may be implemented.

FIG. 2 is an operational flow diagram illustrating an example method of measuring the multi-characteristic degree of comparability of a subject property and each of a set of all available properties in accordance with implementations of the disclosure.

FIG. 3 is a plot showing standardized comparability distances as a function of comparability distances for homogenous versus heterogeneous markets.

FIG. 4 is an operational flow diagram illustrating an example method of objectively scoring a set of comparable properties selected in an appraisal.

FIG. 5 is an empirically created plot showing the cumulative percentage of 100 potential comparable properties (including a set of appraisal properties) as a function of the standardized comparability distances for actual appraisal and comparable property datasets.

FIG. 6, is a bar chart showing a population percentage of potential comparable properties as a function of a comparability score transformed to a scale of 1000.

FIG. 7 is an operational flow diagram illustrating an example method of processing an appraisal report using an input appraisal comparability score, in accordance with implementations.

FIG. 8 is an operational flow diagram illustrating an example method of updating rankings of appraisers in a database using appraisal comparability scores, in accordance with implementations.

FIG. 9 is an operational flow diagram illustrating an example method of presenting a set of most comparable properties to a subject property on an online platform.

FIG. 10 includes tables illustrating a particular example for numerically calculating an overall comparability score for an input appraisal property dataset, in accordance with implementations.

FIG. 11 is an example of a computing module that can be used in conjunction with various embodiments of the present disclosure.

The figures are not intended to be exhaustive or to limit various embodiments to the precise form disclosed. It should be understood that various embodiments can be practiced with modification and alteration.

### DETAILED DESCRIPTION

As noted above, in preexisting processes, a heuristic set of rules is applied to compare the property characteristics of the subject property to the characteristics of the comparable properties in an appraisal. By way of example, a heuristic rule may be a formula that provides arbitrary weights to different characteristics of comparable properties (e.g., a greater weight is applied to a difference in rooms versus a difference in square feet) or includes a rule that a 10% difference in square footage is a threshold for determining whether a property is comparable.

However, comparability is a concept relative to the appraisal subject property, is multi-characteristic and dependent on what is available, or potentially, comparable to the subject. Knowing what was available to be chosen by the appraiser may be as important as knowing what was chosen and being able assess the comparability of the chosen comparable properties as well as the comparability of the potential properties. Heuristic rules generally don't consider the multi-characteristic based nature of comparability. Furthermore, heuristic-based rule sets have no evidence-based determination of the importance of different characteristics and how to “weigh” the differences observed in each characteristic or what, if any, appropriate unacceptable level of difference should be. Finally, the heuristic rules don't consider what is available at the time of the appraisal to “potentially” be selected.

By way of example, consider the case of a market including a subject property that is a tract home in large new suburban community with hundreds of other very similar homes where there is heavy sales transaction activity. This homogeneous and heavily traded, or liquid, market provides many very similar potential property sales transactions that could be used as comparable properties. The expectation would be that the comparable properties in this scenario would be characteristically like the subject.

Alternatively, consider the case of a market including a subject property that has a unique architectural design in a diverse market with a wide variety of different homes built at different times. Additionally, sales happen very rarely in this market. Such a market would be characterized as a heterogeneous thinly-traded, illiquid, market where the likelihood of finding very similar potentially comparable recent transactions is less likely. The expectation would be that the comparable properties that are selected by an appraisal are going to be more dissimilar than the ones in the homogeneous market example, yet that does not mean the appraiser did not select “good” comparable properties. The heuristic rules approach does not account for this fact-comparable property quality is a function of the degree of market homogeneity and liquidity.

The disclosure is directed to addressing the above issues of heuristic models for determining the comparability of properties. To this end, the disclosure describes systems and methods for measuring the multi-characteristic degree of comparability of a subject property and each of a set of potential comparable properties searched in one or more databases based on geographical proximity to the subject property and sale date. In accordance with implementations described herein, a multi-characteristic dimension reduction method may be used that includes derived importance weights of property characteristics to create an objective measure of comparability distance, between a subject property and a compared property. The measure may be applied to calculate the comparability distances, for all potential comparable properties that may be compared to the subject property. For example, a database including recent sales transactions (e.g., within the past two years) within a certain geography of the subject property (e.g., within the neighborhood or radius) can be searched and the distances for all of the returned, or “potential”, properties can be measured using the multi-characteristic dimension reduction method.

In accordance with some implementations, the distance measure may be applied to calculate the comparability distances for all comparable properties selected on an appraisal. In such implementations, the comparability distances of the appraisal selected comparable properties may be compared to the comparability distances for all potential comparable properties to score or otherwise assess the appropriateness of an appraiser selected set. In such implementations, the computed distances may be standardized to account for the market homogeneity and liquidity may be considered in the assessment of the appraiser's selected set. For example, the market homogeneity and liquidity adjusted comparability distances of the appraiser's selected comparable properties may be converted into a single score. In particular implementations, further described below, systems and methods may be provided for the objective scoring of an appraiser's comparable properties, as well as the appraiser based on the set of completed appraisals by the appraiser.

In accordance with some implementations, the distance measure may also be applied to present a set of most comparable properties to a subject property on an online platform. For example, techniques described herein may be used to present a set of most comparable properties to a subject property on a web-based real estate platform that provides data about properties.

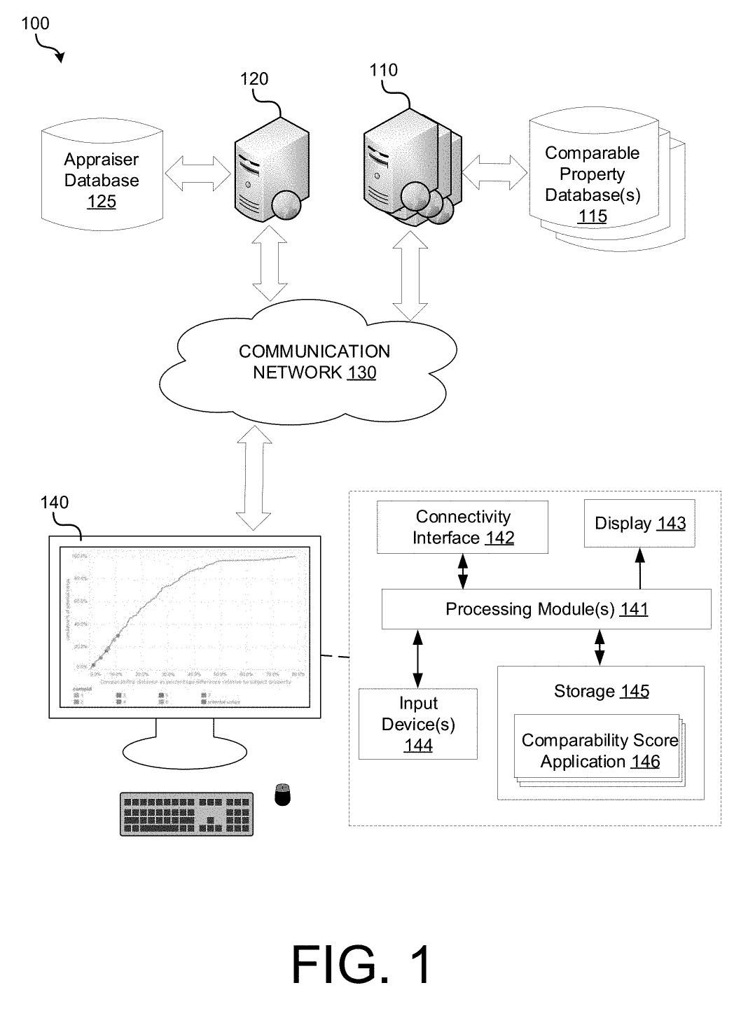

FIG. 1 illustrates an example system 100 in which implementations of the disclosure may be implemented. As shown, system 100 may include a device 140 in communication with an appraiser database 125 and one or more comparable property database(s) 115 over communication network 130. During operation, device 140 may execute machine readable instructions (e.g., comparability score application 146) to measure the multi-characteristic degree of comparability of a subject property and each of a set of all available comparable properties. Additionally, device 140 may execute machine readable instructions (e.g., comparability score application 146) to determine a comparability score for a subset of the comparable properties (e.g., a set of properties that are the subject of an appraisal). To this end, computing device 140 may retrieve sale price and characteristic data for comparable properties from the one or more comparable property database(s) 115. In alternative implementations, device 140 may access a web-based application (e.g., a browser-based application), mobile-based application, or cloud-based application to measure the multi-characteristic degree of comparability of a subject property and each of a set of all available properties and to determine a comparability score.

As illustrated in example system 100, device 140 may retrieve property data from one or more databases 115 using one or more web services gateways 110 that provide application services through one or more web servers. For example, the one or more web services gateways 110 may be in communication with one or more database servers storing the property data. In other implementations, device 140 may access property data from comparable property database(s) 115 using some other network and/or system architecture. In implementations, databases 115 may include, for example, databases of Multiple Listing Service (MLS) organizations, a database including public record data from a county assessor and/or recorded office, or some other database containing property data.

For a given property, the property data that may be retrieved from a database 115 may include, for example, the address, prior sale date(s), prior sale price(s), the year built, the square footage, the lot size, the number of bedrooms, the number of bathrooms, the property type (e.g., house, condo, or townhome), cooling type (if any), fixtures, dimensions of each room, parking spaces, availability of a pool, etc.

As also illustrated in example system 100, device 140 may retrieve appraiser data from an appraiser database 125 using a web services gateway 120 that provides application services through one or more web servers. For example, web services gateway 120 may be in communication with a database server storing the appraiser data. In other implementations, device 140 may access appraiser data 125 using some other network and/or system architecture.

For each appraiser entity (“appraiser”), appraiser database 125 may store appraiser data such as data identifying the appraiser entity, a history of the appraiser's comparability scores (further described below), a cumulative comparability score of the appraiser, a ranking of the appraiser relative to other appraisers, and other data relating to the appraiser's past appraisals such as appraisal documents and the like.

Communication network 130 may include any suitable network whereby device 140 may access property data from databases 115. For example network 130, may include a cloud computing network, an intranet, an extranet, a virtual private network (VPN), a local area network (LAN), a wireless LAN (WLAN), a wide area network (WAN), a portion of the Internet, a satellite network, or any combination thereof. Communications network 130 may use a number of communication mediums, wired and/or wireless.

Device 140 may be any suitable device for measuring the multi-characteristic degree of comparability of a subject property and each of a set of all available properties and to determine a comparability score. As illustrated in the particular example of system 100, device 140 is a desktop computing device that executes a comparability score application 146 to perform these functions. However, in other implementations, comparability score application may be a web-based application and/or cloud-based application.

Device 140 may include one or more processing modules 141, a connectivity interface 142, a display 143, one or more input devices 144 (e.g., mouse, keyboard, microphone, touch-sensitive input, etc.) and storage 145 for storing comparability score application 146. Connectivity interface 142 may comprise a network interface card, a cellular transceiver, or other suitable connectivity interface for accessing communication network 130 and communicating with comparable property database(s) 115 and appraiser database 125.

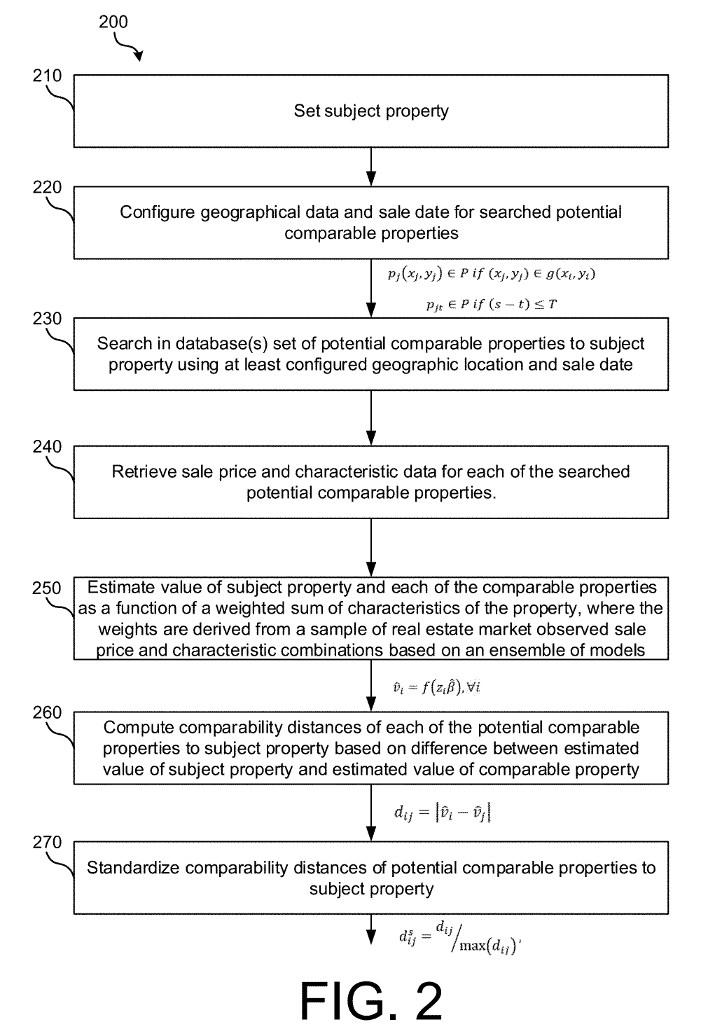

FIG. 2 is an operational flow diagram illustrating an example method 200 of measuring the multi-characteristic degree of comparability of a subject property and each of a set of all available properties in accordance with implementations of the disclosure. It should be noted that although method 200 is annotated with exemplary variables and functions that may be utilized in particular mathematical implementations, further described below, method 200 is not limited to this precise mathematical implementation. In implementations, method 200 may be performed by executing a comparability score application (e.g., application 146). For example, the application may be initialized locally at a device 140 or initialized and/or accessed over a web-based interface.

At operation 210, the subject property may be set. For example, as further described below with reference to specific implementations, the subject property may be a property subject to an appraisal. In other implementations, the subject property may be set as part of a web-based and/or graphical interface for searching subject properties. By way of example, a user of the interface may search the subject property by address and/or geographical coordinates.

Prior to assessing comparability, a set of potential comparable properties P to the subject property may be determined. As such, at operation 220, geographical data and sale date data may be configured for the searched potential comparable properties. For example, to be considered a potential comparable property, a searched property may be within a geographic radius of the subject property and sold within a threshold time (e.g., sold within the last 18 months, 24 months, 30 months, etc.).

In implementations, given the geographic location (xᵢ,yᵢ) of a subject property i, a geographic location (xⱼ,yⱼ) of a comparable property pⱼ, as well as an evaluation date s of the subject property, and an evaluation date t of a potential comparable property, the set of searched potential comparable properties P may be determined based on Equations (1) and (2):

(xⱼ,yⱼ)∈P if (xⱼ,yⱼ)∈g(xᵢ,yᵢ) (1)

pⱼₜ∈P if (s−t)≤T (2)

Where g(xᵢ,yᵢ) is a geographic neighborhood in which the subject property exists and T may be a configurable time value (e.g., in years). In other words, Equations (1)-(2) in this example specify the geography and time dimensions that characterize the set of potential properties.

In implementations, the geographic neighborhood may be a circle of radius, r, centered on the subject location, or may be but is not limited to any other definition of geography such as a zip code or census tract. In particular implementations, the geographic neighborhood may configured based on the absolute location of the comparable properties relative to the subject property (e.g., longitudinal and latitudinal distance).

In particular implementations where the foregoing method is used to assess appraisals (further described below), the evaluation date s of the subject property may specify a date that the subject property was appraised and the evaluation date t may represent a date that a potential comparable property was sold. In other implementations, where the subject property is currently evaluated, the evaluation date s may be the current date.

At operation 230, one or more databases are searched for a set of potential comparable properties to the subject property using at least the configured geographic location and sale date. For example, one or more comparable property databases 115 such as MLS databases, county assessor databases, record office databases, or other databases may be searched for comparable properties that are within the geographic location and sale date. In some implementations, the number of searched comparable properties may be limited to a predetermined threshold. For example, a maximum of 100 potential comparable properties may be found before the search ends. In some implementations, the geographic location and sale date search space may be dynamically expanded during the search if the number of properties that are found during a search do not meet a predetermined threshold (e.g., 100 potential comparable properties).

At operation 240, sale price and characteristic data for each of the searched comparable properties is retrieved from the one or more searched databases. For example, one or more web services gateways 110 may be accessed to retrieve sale price and characteristic data from comparable property database(s) 115 such as MLS databases or other databases containing property data.

Following retrieval of the sale price and characteristic data for each of the comparable properties, an objective single measure of comparability distance, dᵢⱼ, for any pair of properties i and j, may be used to assess comparability of the subject property and set of potential comparable properties.

The comparability distance measure dᵢⱼ may be derived using a multi-characteristic dimension reduction method that includes real-estate market derived importance weights. In implementations, the multi-characteristic dimension reduction method may be applied to derive weights before performing method 200. In such implementations, importance weights may be derived using one or more automated valuation models (AVMs), further described below, that are trained at a certain geographical level (e.g., a county level) such that the derived importance weights may vary for different geographies and models. Alternatively, the multi-characteristic reduction method may be applied during the performance of method 200 (e.g., using retrieving sale price and characteristic data for each of the comparable properties).

By way of mathematical example, the comparability distance dᵢⱼ between a property i and any other property j may be defined by Equations (3)-(4):

dᵢⱼ=|\hat{v}ᵢ−\hat{v}ⱼ| (3)

\hat{v}ᵢ=f(z,\hat{β}),∀i (4)

Where \hat{v}ᵢ is the estimated value of a property i, \hat{v}ⱼ is the estimated value of a property j, and where Equation (4) is a parametrically weighted linear or non-linear function of observable characteristics zᵢ, each characteristic weighted by marginal weights \hat{β}. The observable characteristics may include but are not limited to lot size, age, bedroom count, livable square footage, prior sale value, view, and garage type. Stated differently, equations (3)-(4) may represent the value of a home or other property as a function of all characteristics times the pricing importance weights on them.

The weights \hat{β} for each observable characteristic, may be derived from a sample of real estate market observed sale price pᵢ and characteristic zᵢ combinations (pᵢ,zᵢ) based on the combination of an ensemble of automated valuation models (AVM) that predict the value of a property at a particular point in time, each taking the general form,

vᵢ=f(zᵢβ)+εᵢ (5)

The solution weights, \hat{β}, that minimizes the error εᵢ in the general model described in (5) may be derived from a variety of techniques that may include statistical regression, decisions trees, neural networks, or any machine learning based algorithm. In implementations, the ensemble of AVM models may be weighted such that greater weight is assigned to AVMs that are statistically more likely to provide a more accurate estimate of value.

By way of example, the ensemble of automated valuation models may comprise a multitude of models that relate characteristics of the property with property prices including but not limited to physical, locational or temporal characteristic of the property. The values of the attributes can be assigned weights with a variety of techniques that may include statistical regression, decision trees, neural networks or any other machine learning algorithm. For example, hedonic methods may estimate the value of a property by assigning values to attributes of the property and totaling the values. As another example, neural network models may predict property values using a network training process that forms multiple linear combinations of the property characteristics variables, passes these variables through activation functions, then forms a linear combination of the results that is compared with the observed property value. The coefficients of the linear combinations may be iteratively adjusted such that output of the network converges on the observed property value. Example AVMs and methods of utilizing a weighted ensemble of AVMs to predict property values are further described in U.S. Pat. No. 6,876,955, which is incorporated herein by reference in its entirety.

At operation 250, the value of the subject property and each of the comparable properties may be estimated as a weighted sum of an ensemble of AVMs, discussed above, that estimate the value of each property based on the characteristics of each property. For example, using sales price data and characteristic data retrieved from one or more databases for each property at operation 240, the value of each property may be estimated using each of a plurality of AVMs, and a final estimated value may be derived from a weighted sum of the result of each of the AVMs. In implementations, the value of the subject property and each of the comparable properties may be estimated by applying Equation (4), derived using Equation (5). In other implementations, the value of the subject property and each of the comparable properties may be estimated from a single AVM. For example, using sales price data and characteristic data retrieved from one or more databases for each property at operation 240, the value of each property may be estimated using the single AVM.

In some implementations, the value of the universe of all residential properties, including the subject property and comparable properties, may be automatically calculated at a predetermined frequency (e.g., every day, week, or two weeks) by a system that derives property values using one or more AVMs as discussed above. In such implementations, operation 250 may comprise retrieving or “looking up” the subject property and comparable properties values from the system (e.g., looking up the values calculated by the AVM(s) in a database).

At operation 260, comparability distances of each of the potential comparable properties to the subject property are computed based on the difference between the estimated value of the subject property and the estimated value of the potential comparable property and the subject property. For example, comparability distances may be computed based on equation (3) by taking the absolute value of the differences computed between the subject property and each potential comparable property.

At operation 270, the comparability distances of the potential comparable properties to the subject property are standardized. For example, the comparability distances may be standardized by dividing each of the computed comparability distances by the maximum computed comparability distance. In implementations, the standardized comparability distances di, may be computed based on Equation (6):

dᵢⱼ^{x}=dᵢⱼ/max(dᵢⱼ)∀j for {j:p∈P} (6)

Where P is the set of all potential comparable properties p and i is the subject property.

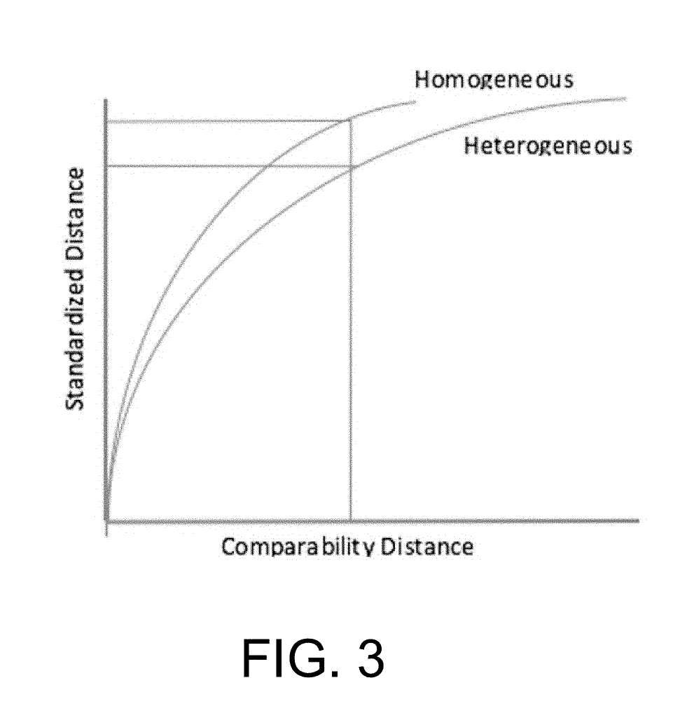

The step of standardization or rescaling relative to the maximum distance may provide the benefit of accounting for the heterogeneity (e.g., illiquid market) or homogeneity (e.g., liquid market) of the market in which the subject property is present. This is illustrated by FIG. 3, which is a plot showing standardized comparability distances as a function of comparability distances for homogenous versus heterogenous markets. As illustrated, properties with the same comparability distance, will have different standardized distances based on market conditions relative to the subject property. The standardized comparability distance may automatically adjust to the subject and market heterogeneity and liquidity. In implementations, further described below, the standardization of the comparability distance may be particularly advantageous in evaluating the performance of an appraisal that selects a set of comparable properties. For example, it would be expected that in a heterogeneous market having unique properties that are geographically dispersed and rarely sold, for the maximum comparability distance to be substantially greater than in a homogenous market having frequently sold properties with few differences.

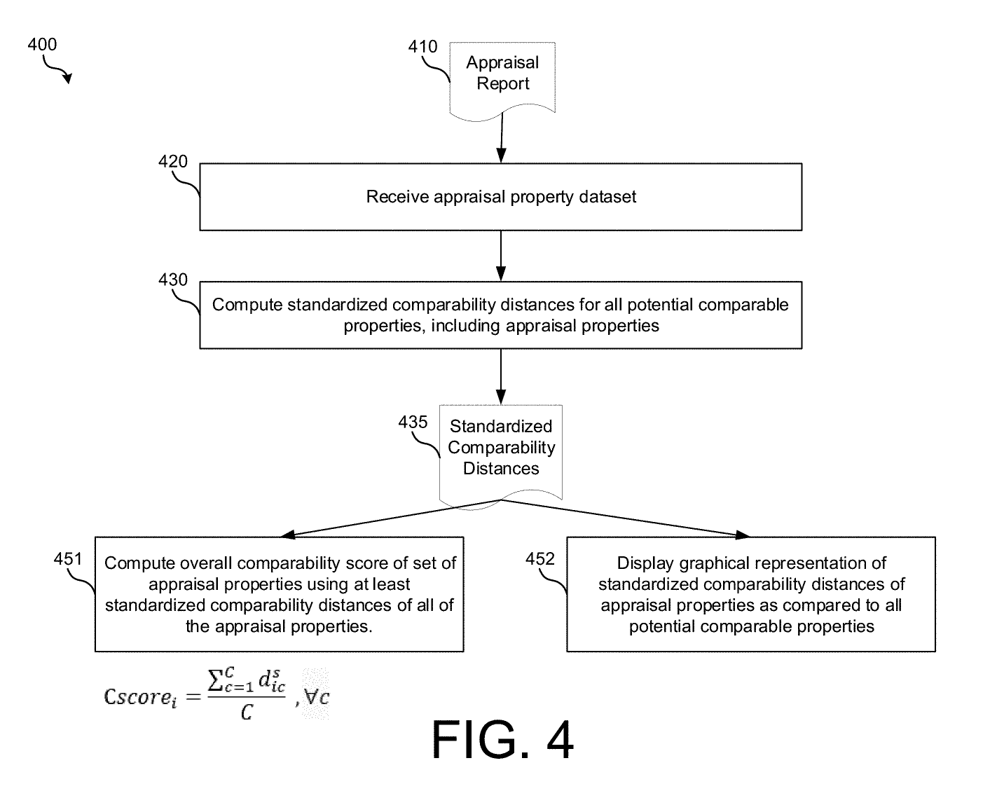

FIG. 4 is an operational flow diagram illustrating an example method 400 of objectively scoring a set of comparable properties selected in an appraisal. It should be noted that although method 400 is annotated with exemplary variables and functions that may be utilized in particular mathematical implementations, further described below, method 400 is not limited to this precise mathematical implementation. In implementations, method 400 may be performed by executing a comparability score application (e.g., application 146). For example, the application may be initialized locally at a device 140 or initialized and/or accessed over a web-based interface.

At operation 420, an appraisal property dataset for a subject property may be received. The appraisal property dataset may include: an identification of each of a set of comparable properties to a subject property, the appraisal date, and, in some implementations, a ranking of the set of comparable properties. The appraisal property dataset may also identify the appraiser. For example, as illustrated in the example of FIG. 4, an appraisal property dataset may be extracted from an appraisal report 410 of a subject property by an appraiser. In implementations, the appraisal property dataset may be extracted from fields in the appraisal report. For example, the appraisal date and an identification of each of the comparable properties identified in the appraisal report (e.g., address or other identification information) may be extracted from data fields in the appraisal report. Additionally, the rankings of the comparable properties in the appraisal report may be extracted from fields in the report. In some implementations, the appraisal report 410 may be retrieved from an appraiser database 125.

At operation 430, for the appraised subject property, standardized comparability distances may be computed for all potential comparable properties to the subject property, including the appraisal properties in the appraisal property dataset. In various implementations, operation 430 may be performed substantially in accordance with method 200 as described above. For example, at operation 220, geographical data and sale date data for searched potential comparable properties may be configured in accordance with Equations (1)-(2), where the evaluation date s in this case may be the appraisal date extracted from the appraisal report. Additionally, operations 250-260 may be performed with respect to the appraisal properties, in addition to all other comparable properties. It should be noted that in many instances the potential comparable properties may include some or all of the appraisal properties.

Further still, the appraisal property set may be considered as part of a larger potential comparable property set in determining the maximum comparability distance, and standardized comparability distances may also be determined for each of the appraised properties. For example, given a set P of potential comparable properties p and a set C of comparable properties c provided in the appraisal report, Equation (6) may be rewritten as:

dᵢⱼ^{x}=dᵢⱼ/max(dᵢⱼ)∀j for {j:c∈C,p∈P} (7)

The output of operation 430 is the standardized comparability distances 435 for all potential comparable properties, including the appraisal properties. This output may be subsequently applied to provide an object evaluation of an appraiser.

For example, at operation 451, an overall comparability score of the set of selected appraisal properties may be computed using at least the standardized comparability distances of all of the appraisal properties. In some implementations, the overall comparability score may also take into account the ranking that was applied to each of the appraisal properties in the appraisal report. In a particular mathematical implementation, an overall comparability score for a subject property i may be computed based on Equation (8):

$${Cscore}_{i} = \frac{{\sum }_{c = 1}^{C} {d}_{ic}^{s}}{C} , ∀ c \qquad ( 8 )$$

Where Cscoreᵢ is the mean standardized comparability distance (but may be any summary function) of all the appraisal's comparable properties. In this example, the overall appraisal comparability score reflects the average comparability distance of the selected comparable properties to the subject within the context of the subject property and market homogeneity and market liquidity, and it may change over time. The higher the score, the more potential comparable properties there are within the potential set, P, with smaller standardized distance, dᵢⱼ^{x} This may be used as an indication of the decreased quality of the final appraisal result. The computed comparability score may be displayed as an output of an application (e.g., comparability score application 146) and/or used to update an overall score or ranking of appraiser (further described below).

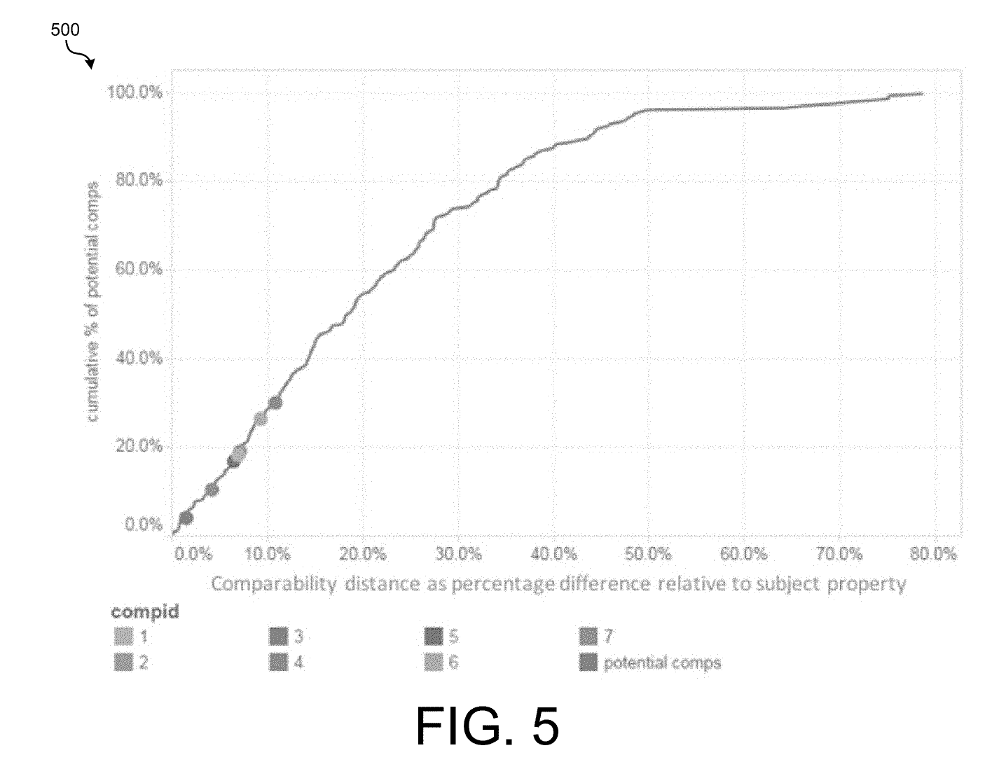

At operation 452, a graphical representation of the standardized comparability distances of the appraisal properties as compared to the standardized comparability distances of all potential comparable properties may be displayed (e.g. as part of a graphical user interface of a comparability score application 146). FIG. 5 is a plot 500 showing one such graphical representation in accordance with implementations. FIG. 5 is an empirically created plot (using Equations (1)-(7)) showing the cumulative percentage of 100 potential comparable properties (including a set of appraisal properties) as a function of the standardized comparability distances (e.g. comparability distance as percentage difference relative to subject property) for actual appraisal and comparable property datasets. As illustrated, almost 60% of potential comparable properties have a standardized comparability distance that is 20% or less. As also illustrated, all of the comparable properties selected on the appraisal have a standardized comparability distance of 12% or less and are within the first 30% of potential comparable properties. In some implementations plot 500 may also display the mean standardized distance of the appraisal's comparable properties (e.g., derived using Equation (8)).

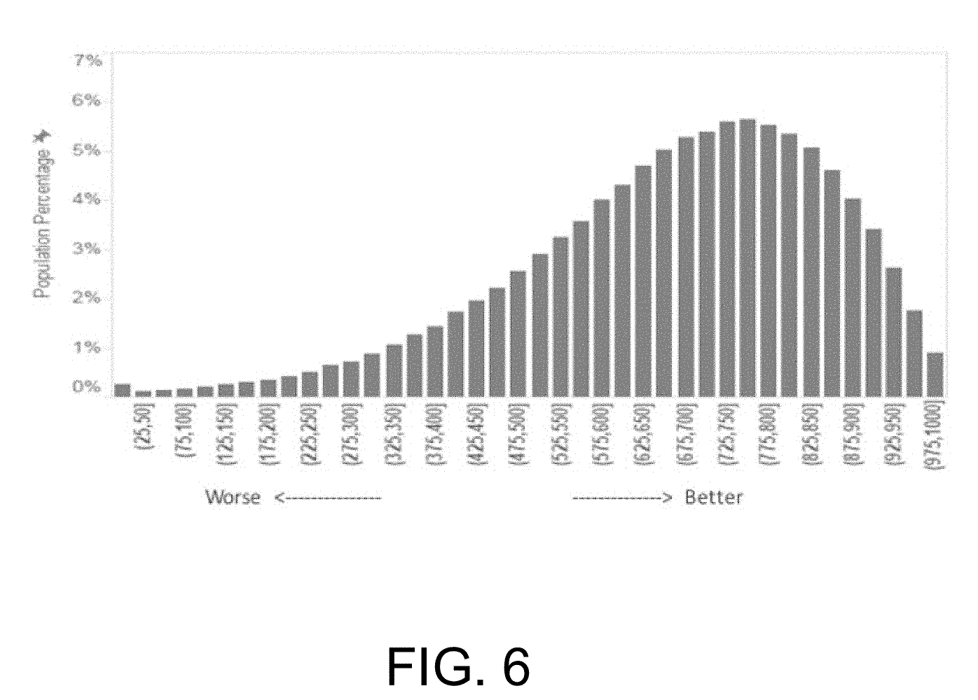

In some implementations, a computed comparability score may be transformed into any scale for display and/or evaluation of an appraiser, or for any other purpose. For example, a comparability score may be transformed into a scale of 0 to 1000, where 1000 indicates very small (good) mean standardized comparability distance for the appraisal comparable properties. This is illustrated by FIG. 6, which is a bar chart showing a population percentage of potential comparable properties as a function of a comparability score transformed to a scale of 1000. Scoring ranges are shown in increments of 25.

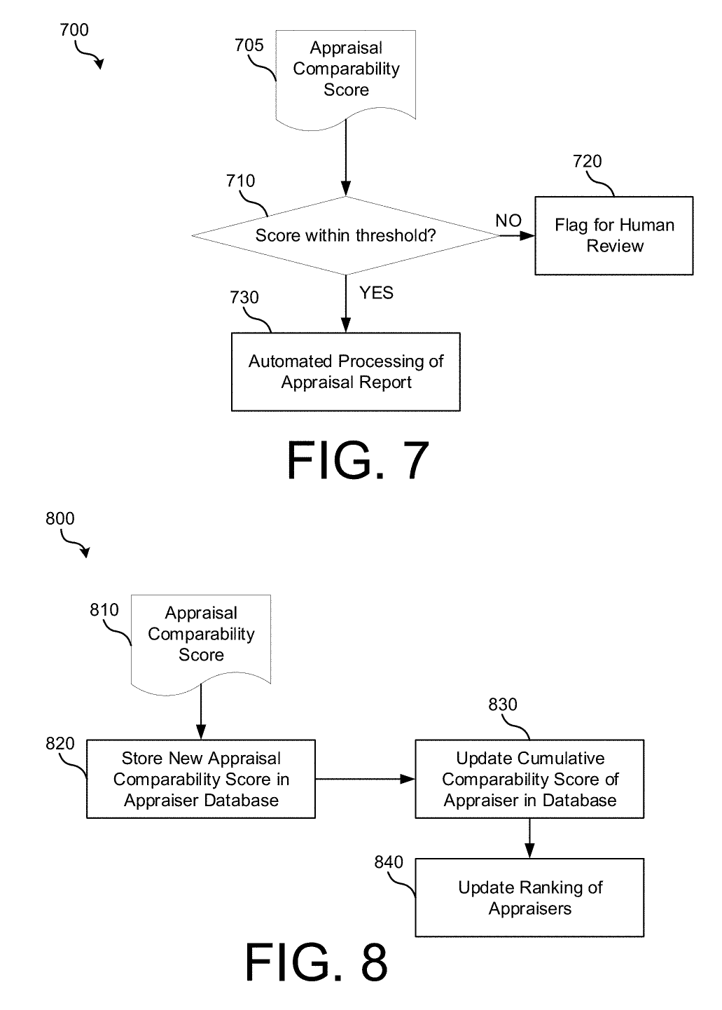

FIG. 7 is an operational flow diagram illustrating an example method 700 of processing an appraisal report using an input appraisal comparability score 705, in accordance with implementations. For example, appraisal comparability score 705 may have been calculated in accordance with method 400.

At decision 710, it is determined whether appraisal comparability score 705 is within a threshold. For example, it may be determined whether appraisal comparability score 705 is within a certain standardized comparability distance (e.g., within 20% of the subject property) and/or whether it is greater than or equal to the standardized comparability distances of a certain percentage of potential comparable properties (e.g., 90%). As another example, where score 705 is a score transformed to a scale of 1000 (e.g., as discussed above with reference to FIG. 6), it may be determined whether score exceeds or is equal to a certain threshold (e.g., 900). As would be appreciated, the threshold parameter may be set using one or more parameters, including, for example, the percentage of potential comparable properties that fall within a certain standardized comparability distance, the comparability distance as a percentage difference relative to a subject property, and/or the total number of available potential comparable properties. In implementations, the threshold parameter may configured using a comparability score application as described above or other suitable application.

If the score is not within a threshold (indicating a substandard appraisal), at operation 720 the appraisal report may be flagged by an application for human review. For example, an email notification, a web-based notification, or other notification indicating that the appraisal requires additional review may be transmitted over a network to a party that contracted the appraiser (e.g., a lender). If the score is within the threshold (indicating the appraisal is of sufficient quality), at operation 730 the appraisal report may be automatically processed by a system. For example, a system of a lender deciding whether or not to finance a mortgage may extract the appraisal value from a field in the appraisal report and make a determination of whether the appraisal value exceeds or equals the purchase price.

FIG. 8 is an operational flow diagram illustrating an example method 800 of updating rankings of appraisers in a database using appraisal comparability scores 810, in accordance with implementations. For example, appraisal comparability score 810 may be calculated in accordance with method 400. In implementations, method 800 may be performed by executing a web-based application, cloud-based application, or other suitable application.

At operation 820, a new appraisal comparability score 810 is stored in an appraiser database. For example, score 810 may be stored in an appraiser database 125 and associated with an appraiser entity in the database 125. At operation 830, a cumulative comparability score of the appraiser associated with score 810 is updated in the database. The cumulative score is updated using the new appraisal comparability score. In some implementations, the appraiser's cumulative score may be updated by taking the mean of the new score and all past comparability scores of the appraiser. In some implementations, the cumulative score may be updated by taking a weighted mean of the new comparability score and all past comparability scores. The weighted mean may take into account factors such as, for example, the date the comparability score was generated (e.g., higher weights for more recent scores), the liquidity of the market in which the score was generated, the uniqueness of the property, and other considerations.

At operation 840, following an update of the cumulative comparability score, a ranking of appraisers in the appraiser database may be updated. For example, if the updated cumulative comparability score of the appraiser raises it above the score of another appraiser, appraiser rankings stored in the appraiser database may be updated.

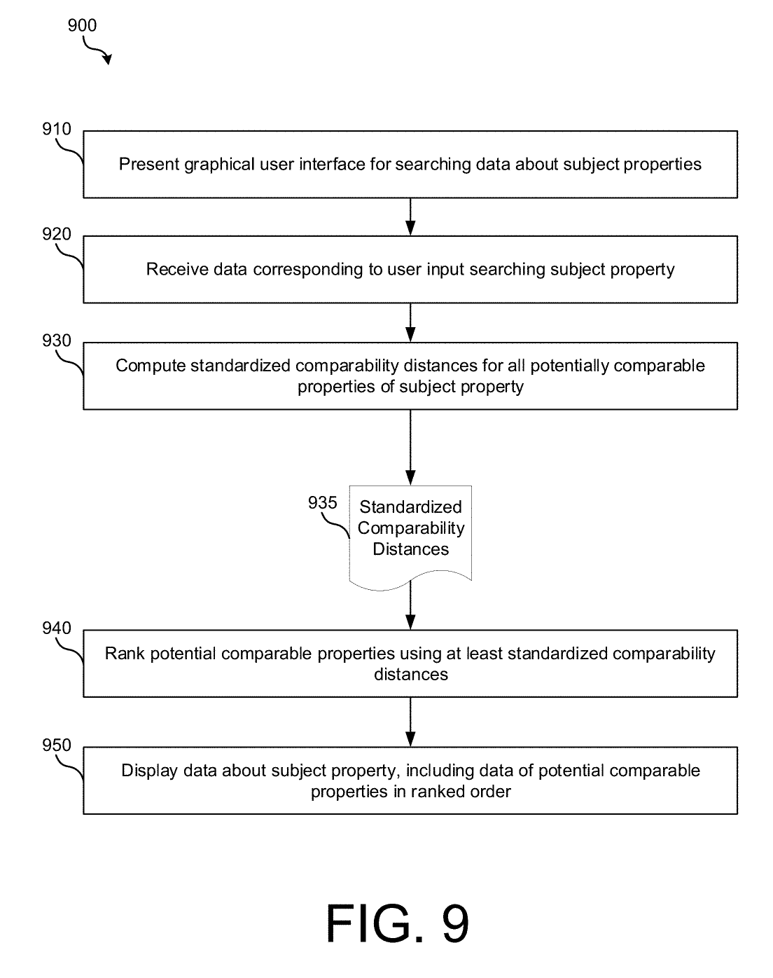

FIG. 9 is an operational flow diagram illustrating an example method 900 of presenting a set of most comparable properties to a subject property on an online real-estate platform. For example, method 900 may be implemented by executing machine-readable instructions at one or more servers and presenting a web-based or application-based interface to a user viewing real-estate properties on the online real-estate platform. At operation 910, a graphical user interface for searching data about subject properties is presented to a user. For example, a user may be presented, at a web-based interface, with a search box for searching properties by address. The interface may also display a map to the user for searching properties. At operation 920, the interface may receive data corresponding to user input searching a subject property. For example, the user may enter an address or select a property displayed on a map.

Upon identification of the subject property, at operation 930 the system may compute standardized comparability distances 935 for all potential comparable properties of the subject property. In various implementations, the standardized comparability distances may be computed in accordance with method 200, described above. For example, the set of potential comparable properties may be limited based on geographical proximity to the subject property, their sale date, and/or a predetermined maximum number of potential comparable properties.

At operation 940, potential comparable properties may be ranked using at least the computed standardized comparability distances 935. For example, properties having a lower standardized comparability distance may be ranked higher than a corresponding property. In some implementations, potential comparable properties that do not meet other criteria (e.g., user-defined pricing or room number criteria) may be filtered out of the ranking results.

At operation 950, data about the subject property searched by the user, including data of the potential comparable properties in ranked order, may be displayed to the user. For example, the user interface may be display characteristics about the subject property in addition to a graphical list of the 10 most comparable properties (or some other number of most comparable properties), in ranked order.

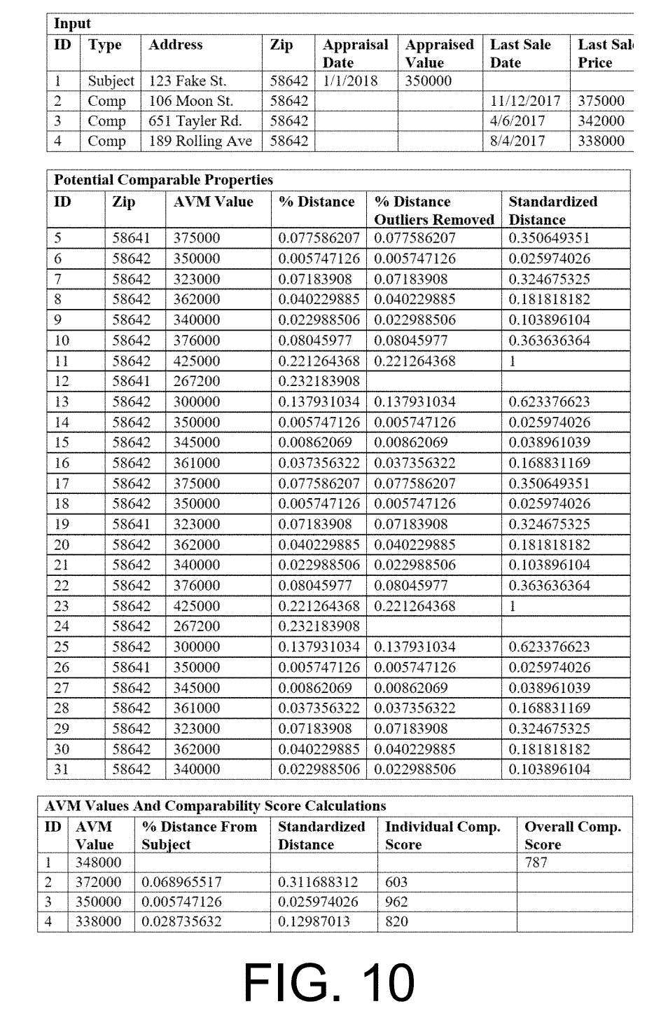

FIG. 10 includes tables illustrating a particular example for numerically calculating an overall comparability score for an input appraisal property dataset, in accordance with implementations. For example, the overall comparability score may be calculated by following the process outlined in methods 200 and 400.

In this particular example, the input appraisal dataset includes a subject property (ID 1), three comparable properties identified by the appraiser (ID 2-4), an appraisal date, and an appraisal value. A total of 30 potential comparable properties to the subject property, including the appraisal comparable properties, were identified (ID 2-31).

AVM values were determined for each of the potential comparable properties, and comparability distances in this example were calculated as a percentage difference in AVM value by taking the absolute value of the difference between AVM value of subject property/AVM value of comparable property −1. Potential comparable properties that were outliers in comparability distance (in this example, having a comparability distance greater than the 95 percentile), were removed from the dataset. Standardized comparability distances were then calculated for the remaining properties, including the appraisal comparable properties. Based on the standardized comparability distances of all potential comparable properties and the appraisal comparable properties, an individual comparability score (normalized to a scale of 1000) was calculated for each appraisal property. An overall comparability score was calculated based on a weighted sum of the individual comparability scores.

As used herein to describe a user interface (UI) or graphical user interface (GUI), the term “user input” or “input” generally refers to any user action that generates data that triggers one or more actions at the UI. A user input may include, for example, a touch user interface gesture (e.g., taps, holds, swipes, pinches, etc.), vocal input (e.g., voice commands that are digitized and translated into a corresponding action), a keyboard input (e.g., pressing a keyboard key), a mouse input (e.g., clicking and/or moving a mouse pointer), and the like. User input may include a sequence of inputs, such as a particular sequence of touch gestures, voice commands, and/or key presses. User input may select, modify, or otherwise manipulate a displayed graphical control element such as, for example, buttons, checkboxes, menus, windows, sliders, navigational control elements, and the like.

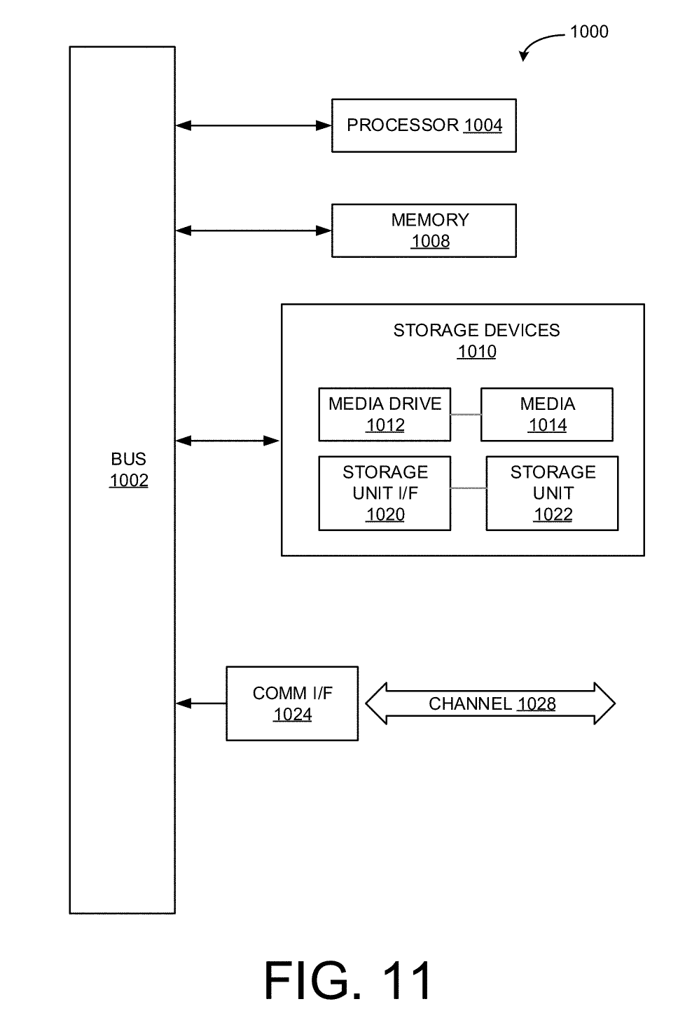

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module 1000 is shown in FIG. 11, which may be used to implement various features of the methods disclosed herein. For example, computing module 1000 may used to implement some or all of the operations of methods 200, 400, 700, 800, and 900. After reading this description, it will become apparent to a person skilled in the relevant art how to implement the application using other computing modules or architectures.

Referring now to FIG. 11, computing module 1000 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 1000 might also represent computing capabilities embedded within or otherwise available to a given device. For example, a computing module might be found in other electronic devices such as, for example, cellular telephones, portable computing devices, modems, routers, WAPs, terminals and other electronic devices that might include some form of processing capability.

Computing module 1000 might include, for example, one or more processors, controllers, control modules, or other processing devices, such as a processor 1004. Processor 1004 might be implemented, for example, as a microprocessor, controller, or other control logic. In the illustrated example, processor 1004 is connected to a bus 1002, although any communication medium can be used to facilitate interaction with other components of computing module 1000 or to communicate externally.

Computing module 1000 might also include one or more memory modules, simply referred to herein as main memory 1008. For example, random access memory (RAM) or other dynamic memory, might be used for storing information and instructions to be executed by processor 1004. Main memory 1008 might also be used for storing temporary variables or other intermediate information during execution of instructions to be executed by processor 1004. Computing module 1000 might likewise include a read only memory (“ROM”) or other static storage device coupled to bus 1002 for storing static information and instructions for processor 1004.

The computing module 1000 might also include one or more various forms of information storage mechanism 1010, which might include, for example, a media drive 1012 and a storage unit interface 1020. The media drive 1012 might include a drive or other mechanism to support fixed or removable storage media 1014. For example, a hard disk drive, a solid state drive, a magnetic tape drive, an optical disk drive, a CD, DVD, or BLU-RAY drive (R or RW), or other removable or fixed media drive might be provided. Accordingly, storage media 1014 might include, for example, a hard disk, a solid state drive, magnetic tape, cartridge, optical disk, a CD, a DVD, a BLU-RAY, or other fixed or removable medium that is read by, written to or accessed by media drive 1012. As these examples illustrate, the storage media 1014 can include a computer usable storage medium having stored therein machine readable instructions or data.

In alternative embodiments, information storage mechanism 1010 might include other similar instrumentalities for allowing computer programs or other instructions or data to be loaded into computing module 1000. Such instrumentalities might include, for example, a fixed or removable storage unit 1022 and an interface 1020. Examples of such storage units 1022 and interfaces 1020 can include a program cartridge and cartridge interface, a removable memory (for example, a flash memory or other removable memory module) and memory slot, a PCMCIA slot and card, and other fixed or removable storage units 1022 and interfaces 1020 that allow software and data to be transferred from the storage unit 1022 to computing module 1000.

Computing module 1000 might also include a communications interface 1024. Communications interface 1024 might be used to allow software and data to be transferred between computing module 1000 and external devices. Examples of communications interface 1024 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1024 might typically be carried on signals, which can be electronic, electromagnetic (which includes optical) or other signals capable of being exchanged by a given communications interface 1024. These signals might be provided to communications interface 1024 via a channel 1028. This channel 1028 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer readable medium”, “computer usable medium” and “computer program medium” are used to generally refer to non-transitory mediums, volatile or non-volatile, such as, for example, memory 1008, storage unit 1022, and media 1014. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1000 to perform features or functions of the present application as discussed herein.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

What is claimed is:

1. A method comprising:
initializing an application instance;
setting, at the application instance, a subject property;
searching one or more databases for a plurality of potential comparable properties to the subject property using at least a configured geographical proximity to the subject property and a configured sale date;
retrieving, from the one or more databases, sales price and characteristic data for each of the searched plurality of potential comparable properties;
estimating a value of the subject property and each of the plurality of potential comparable properties as a function of a weighted sum of characteristics of the property, wherein weights for the weighted sum are derived from a sample of observed sale price and characteristic combinations based on one or more automated valuation models;
computing comparability distances of each of the potential comparable properties to the subject property based on a difference between the estimated value of the subject property and the estimated value of the potential comparable property; and
standardizing each of the computed comparability distances.

2. The method of claim 1, further comprising: receiving an appraisal property dataset comprising a plurality of properties comparable to the subject property, wherein the operations of estimating a value, computing a comparability distance to the subject property, and standardizing the computed comparability distance are performed for each of the plurality of properties of the appraisal property dataset.

3. The method of claim 2, wherein the computed comparability distances are standardized based on dᵢⱼ^{x}=dᵢⱼ/max(dᵢⱼ)∀j for {j:c∈C,p∈P}, wherein dᵢⱼ^{x} is a standardized comparability distance of a potential comparable property j to the subject property i, wherein C is a set including each of the plurality of properties c of the appraisal dataset, and wherein P is a set including each of the plurality of properties p of the potential comparable properties.

4. The method of claim 3, further comprising: determining a comparability score of the plurality of properties of the appraisal property dataset using at least the standardized comparability distance computed for each of the properties of the appraisal property dataset.

5. The method of claim 4, wherein the comparability score is determined based on
$${Cscore}_{i} = \frac{{\sum }_{c = 1}^{C} {d}_{ic}^{s}}{C} , ∀ c ,$$
wherein Cscoreᵢ is the mean standardized comparability distance of the standardized comparability distances of the plurality of properties of the appraisal property dataset.

6. The method of claim 4, further comprising: determining if the comparability score exceeds a threshold standardized comparability distance.

7. The method of claim 4, further comprising: displaying a graphical representation of the standardized comparability distances of the plurality of properties of the appraisal property dataset as compared to the standardized comparability distances of the plurality of potential comparable properties.

8. The method of claim 7, wherein the graphical representation is a plot showing a cumulative percentage of the plurality of potential comparable properties as a function of standardized comparability distance.

9. The method of claim 1, wherein weights for the weighted sum are derived from a sample of observed sale price and characteristic combinations based on a weighted ensemble of a plurality of automated valuation models.

10. The method of claim 4, further comprising:
storing the comparability score in an appraisal database;
updating a cumulative comparability score of an appraiser associated with the appraisal dataset in the appraisal database using at least the determined comparability score; and
updating a ranking of the appraiser in the appraiser database using at least the updated cumulative comparability score and stored cumulative comparability scores of other appraisers.

11. The method of claim 1, wherein setting the subject property comprises:
presenting a graphical user interface for searching data about the subject property; and
receiving data corresponding to user input searching the subject property, wherein the method further comprises:
ranking the potential comparable properties using at least the standardized comparability distances; and
displaying data about the potential comparable properties in ranked order.

12. A system, comprising: one or more non-transitory computer-readable mediums having instructions stored thereon that, when executed by one or more processors, causes the system to:
set a subject property;
search one or more databases for a plurality of potential comparable properties to the subject property using at least a configured geographical proximity to the subject property and a configured sale date;
retrieve, from the one or more databases, sales price and characteristic data for each of the searched plurality of potential comparable properties;
estimate a value of the subject property and each of the plurality of potential comparable properties as a function of a weighted sum of characteristics of the property, wherein weights for the weighted sum are derived from a sample of observed sale price and characteristic combinations based on one or more automated valuation models;
compute comparability distances of each of the potential comparable properties to the subject property based on a difference between the estimated value of the subject property and the estimated value of the potential comparable property; and
standardize each of the computed comparability distances.

13. The system of claim 12, wherein the instructions, when executed by one or more processors, further cause the system to: receive an appraisal property dataset comprising a plurality of properties comparable to the subject property, wherein the operations of estimating a value, computing a comparability distance to the subject property, and standardizing the computed comparability distance are performed for each of the plurality of properties of the appraisal property dataset.

14. The system of claim 13, wherein the computed comparability distances are standardized based on dᵢⱼ^{x}=dᵢⱼ/max(dᵢⱼ)∀j for {j:c∈C,p∈P}, wherein dᵢⱼ^{x} a standardized comparability distance of a potential comparable property j to the subject property i, wherein C is a set including each of the plurality of properties c of the appraisal dataset, and wherein P is a set including each of the plurality of properties p of the potential comparable properties.

15. The system of claim 14, wherein the instructions, when executed by one or more processors, further cause the system to: determine a comparability score of the plurality of properties of the appraisal property dataset using at least the standardized comparability distance computed for each of the properties of the appraisal property dataset.

16. The system of claim 15, wherein the comparability score is determined based on
$${Cscore}_{i} = \frac{{\sum }_{c = 1}^{C} {d}_{ic}^{s}}{C} , ∀ c ,$$
wherein Cscoreᵢ is the mean standardized comparability distance of the standardized comparability distances of the plurality of properties of the appraisal property dataset.

17. The system of claim 14, wherein the instructions, when executed by one or more processors, further cause the system to: display a graphical representation of the standardized comparability distances of the plurality of properties of the appraisal property dataset as compared to the standardized comparability distances of the plurality of potential comparable properties.

18. The system of claim 12, wherein weights for the weighted sum are derived from a sample of observed sale price and characteristic combinations based on a weighted ensemble of a plurality of automated valuation models.

19. The system of claim 15, wherein the instructions, when executed by one or more processors, further cause the system to:
store the comparability score in an appraisal database;
update a cumulative comparability score of an appraiser associated with the appraisal dataset in the appraisal database using at least the determined comparability score; and
update a ranking of the appraiser in the appraiser database using at least the updated cumulative comparability score and stored cumulative comparability scores of other appraisers.

20. The system of claim 12, wherein setting the subject property comprises:
presenting a graphical user interface for searching data about the subject property; and
receiving data corresponding to user input searching the subject property, wherein the instructions, when executed by one or more processors, further cause the system to:
rank the potential comparable properties using at least the standardized comparability distances; and
display data about the potential comparable properties in ranked order.
